(19) United States
(12) Patent Application Publication
(10) Pub. No.: US 2024/0403175 A1
(43) Pub. Date: Dec. 5, 2024

(54) DATA STORAGE SYSTEM AND METHOD

(71) Applicant: Huawei Technologies Co., Ltd., Shenzhen (CN)

(72) Inventors: Qian Pan, Shenzhen (CN); Qian Wang, Chengdu (CN); Lang Ren, Hangzhou (CN); Pengfei Qin, Hangzhou (CN); Xianhong Wang, Chengdu (CN)

(21) Appl. No.: 18/804,816

(22) Filed: Aug. 14, 2024

Related U.S. Application Data
(63) Continuation of application No. PCT/CN2023/074711, filed on Feb. 7, 2023.

(30) Foreign Application Priority Data
Feb. 16, 2022 (CN) 202210140120.6

(51) Int. Cl. G06F 11/20; G06F 11/30

(52) U.S. Cl. CPC G06F 11/2025; G06F 11/3034

(57) ABSTRACT

This disclosure related to a storage cluster includes two storage nodes, and the two storage nodes are respectively a primary storage node and a secondary storage node. The primary storage node is configured to obtain data from a container management cluster, store the data in a local database of the primary storage node, and send the data to the secondary storage node. Correspondingly, the secondary storage node is configured to receive the data from the primary storage node, and store the data in a local database of the secondary storage node.

### CROSS-REFERENCE TO RELATED APPLICATIONS

This application is a continuation of International Application No. PCT/CN2023/074711, filed on Feb. 7, 2023, which claims priority to Chinese Patent Application No. 202210140120.6, filed on Feb. 16, 2022. The disclosures of the aforementioned applications are hereby incorporated by reference in their entireties.

### TECHNICAL FIELD

This disclosure relates to the field of information technologies, and in particular, to a data storage system and method.

### BACKGROUND

With development and popularity of a container technology represented by an disclosure container engine (a docker), the container technology is gradually accepted and popularized in the industry. Problems resolved by a container engine and mirroring that are of a single machine are very limited. If a container is to be used directly in a production environment, a container management cluster needs to be depended on. The container management cluster usually aims to resolve a problem such as orchestration, scheduling, or cluster management of the container. Currently, the container management cluster in the industry is mainly a Kubernetes cluster.

The Kubernetes cluster may use an ETCD cluster as a storage backend of data. Various storage nodes in the ETCD cluster implement data synchronization of a plurality of storage nodes in the ETCD cluster based on a distributed consensus algorithm (Raft), and select a primary storage node from the plurality of storage nodes. In the ETCD cluster, at least three storage nodes need to be deployed, to ensure data storage with high availability.

In a scenario in which a quantity of nodes is limited, three nodes deployed in the ETCD cluster may not be ensured. Consequently, the consensus algorithm Raft cannot be run to implement high availability of data storage.

### SUMMARY

This disclosure provides a data storage system and method. A storage cluster in the data storage system may be for storing data in a container management cluster. The storage cluster may be provided with two storage nodes, and the two storage nodes are respectively a primary storage node and a secondary storage node. High availability of data storage is implemented in a primary-and-secondary manner.

According to a first aspect, this disclosure provides a data storage system, including a storage cluster. The storage cluster includes two storage nodes, and the two storage nodes are respectively a primary storage node and a secondary storage node. The primary storage node is configured to obtain data from a container management cluster, store the data in a local database of the primary storage node, and send the data to the secondary storage node. Correspondingly, the secondary storage node is configured to receive the data from the primary storage node, and store the data in a local database of the secondary storage node.

In this way, the data is stored in both the local database of the primary storage node and the local database of the secondary storage node, thereby ensuring high availability of data storage. In addition, one storage cluster may include only two storage nodes, thereby reducing a quantity of storage nodes.

In a possible implementation, the primary storage node further includes a proxy interface, and the proxy interface of the primary storage node communicates with an application programming interface (API) server in the container management cluster. The proxy interface of the primary storage node is for receiving a first request from the API server, where the first request includes the data to be stored in the local database of the primary storage node. Then, the proxy interface of the primary storage node performs protocol conversion on the first request, to obtain a second request supported by the local database of the primary storage node. Then, the proxy interface of the primary storage node is further for sending the second request to the local database of the primary storage node, and the local database of the primary storage node is configured to store the data included in the second request.

In this way, the proxy interface of the primary storage node may convert a request from the API server in the container management cluster into a request complying with an interface of the local database of the primary storage node. For example, when the local database of the primary storage node is MySQL, the proxy interface of the primary storage node converts the request from the API server into a request complying with a MySQL interface, so that the container management cluster reads and writes the data in the local database of the primary storage node.

In a possible implementation, the data storage system further includes an arbitration node, the arbitration node is separately connected to the primary storage node and the secondary storage node, and the arbitration node is configured to monitor working statuses of the primary storage node and the secondary storage node. When determining that the working status of the primary storage node changes from “normal” to “failed” and the working status of the secondary storage node is “normal”, the arbitration node switches the secondary storage node to the primary storage node in the storage cluster. Correspondingly, when the container management cluster needs to store the data in the storage cluster, the container management cluster may send the data to the new primary storage node, and the new primary storage node may store the data.

This helps ensure high availability of data in the entire storage system. In addition, the arbitration node monitors the working statuses of the primary storage node and the secondary storage node, and indicates the secondary storage node to switch to the primary storage node, to help avoid a split-brain problem caused by mutual monitoring between the primary storage node and the secondary storage node.

In a possible implementation, there are a plurality of storage clusters. The data storage system further includes an arbitration node, and the arbitration node is separately connected to two storage nodes in each storage cluster. The arbitration node is configured to monitor working statuses of the two storage nodes in each storage cluster. For any one of the plurality of storage clusters, when determining that a working status of a primary storage node in the storage cluster changes from “normal” to “failed” and a working status of a secondary storage node is “normal”, the arbitration node switches the secondary storage node in the storage cluster to the primary storage node in the storage cluster. Correspondingly, when the container management cluster needs to store the data in the storage cluster, the container management cluster may send the data to the new primary storage node, and the new primary storage node may store the data.

This helps ensure high availability of data in the entire storage system. In addition, the arbitration node monitors the working statuses of the primary storage node and the secondary storage node, and indicates the secondary storage node to switch to the primary storage node, to help avoid a split-brain problem caused by mutual monitoring between the primary storage node and the secondary storage node. In addition, the arbitration node monitors working statuses of primary storage nodes and secondary storage nodes in the plurality of storage clusters, to help reduce deployment costs in the storage system. In addition, when a quantity of storage clusters gradually increases, the deployment costs that can be saved in the storage system are also larger.

In a possible implementation, when switching the secondary storage node to the primary storage node in the storage cluster, the arbitration node is specifically configured to send a switch indication to the secondary storage node. The switch indication indicates the secondary storage node to switch to the primary storage node in the storage cluster. Correspondingly, the secondary storage node is further configured to switch to the primary storage node in the storage cluster based on the switch indication. In this way, the secondary storage node in the storage cluster switches to the primary storage node in the storage cluster based on an indication of the arbitration node, thereby helping ensure high availability and orderliness of data in the entire storage system.

In a possible implementation, the local database includes one or more of Oracle, MySQL, MongoDB, Redis, or the like. Specifically, both the local database of the primary storage node and the local database of the secondary storage node may include one or more of Oracle, MySQL, MongoDB, Redis, or the like.

In a possible implementation, the container management cluster is a Kubernetes cluster.

According to a second aspect, this disclosure provides a data storage method. The method is applied to a data storage system. The data storage system includes a storage cluster, the storage cluster includes two storage nodes, and the two storage nodes are respectively a primary storage node and a secondary storage node. The method includes: The primary storage node obtains data from a container management cluster, stores the data in a local database of the primary storage node, and sends the data to the secondary storage node. The secondary storage node stores the data in a local database of the secondary storage node.

In a possible implementation, the primary storage node further includes a proxy interface, and the proxy interface of the primary storage node communicates with an API server in the container management cluster. That the primary storage node obtains data from a container management cluster, stores the data in a local database of the primary storage node may specifically include: The proxy interface of the primary storage node receives a first request from the API server, where the first request includes the data to be stored in the local database of the primary storage node. The proxy interface of the primary storage node performs protocol conversion on the first request, to obtain a second request supported by the local database of the primary storage node; and sends the second request to the local database of the primary storage node. The local database of the primary storage node stores the data included in the second request.

In a possible implementation, the data storage system further includes an arbitration node, and the arbitration node is separately connected to the primary storage node and the secondary storage node. The arbitration node monitors working statuses of the primary storage node and the secondary storage node; and when the working status of the primary storage node changes from “normal” to “failed” and the working status of the secondary storage node is “normal”, the arbitration node switches the secondary storage node to the primary storage node in the storage cluster.

In a possible implementation, there are a plurality of storage clusters. The data storage system further includes an arbitration node, and the arbitration node is separately connected to two storage nodes in each storage cluster. The arbitration node monitors working statuses of the two storage nodes in each storage cluster; and when a working status of a primary storage node changes from “normal” to “failed” and a working status of a secondary storage node is “normal” in any one of the plurality of storage clusters, the arbitration node may switch the secondary storage node in the storage cluster to the primary storage node in the storage cluster.

In a possible implementation, that the arbitration node switches the secondary storage node to the primary storage node in the storage cluster includes: The arbitration node sends a switch indication to the secondary storage node, where the switch indication indicates the secondary storage node to switch to the primary storage node in the storage cluster. The secondary storage node switches to the primary storage node in the storage cluster based on the switch indication.

In a possible implementation, the local database includes one or more of Oracle, MySQL, MongoDB, Redis, or the like. Specifically, both the local database of the primary storage node and the local database of the secondary storage node may include one or more of Oracle, MySQL, MongoDB, Redis, or the like.

In a possible implementation, the container management cluster is a Kubernetes cluster.

According to a third aspect, this disclosure provides a data storage device, including a processor. The processor is connected to a memory, the memory is configured to store a computer program, and the processor is configured to execute the computer program stored in the memory, to enable the data storage device to perform the method in any one of the second aspect or the possible implementations of the second aspect.

According to a fourth aspect, this disclosure provides a computer-readable storage medium, where the computer-readable storage medium stores a computer program or instructions. When the computer program or the instructions are executed by a data storage device, the method in any one of the second aspect or the possible implementations of the second aspect is implemented.

According to a fifth aspect, this disclosure provides a computer program product, where the computer program product includes a computer program or instructions. When the computer program or the instructions are executed by a data storage device, the data storage device implements the method in any one of the second aspect or the possible implementations of the second aspect.

For technical effects that can be achieved in any one of the foregoing second aspect to the fifth aspect, refer to descriptions of beneficial effects in the first aspect. Details are not described herein again.

### BRIEF DESCRIPTION OF THE DRAWINGS

FIG. 1 is a diagram of an architecture of a system according to this disclosure;

FIG. 2 is a diagram of an architecture of a data storage system according to this disclosure;

FIG. 3 is a diagram of proxy interfaces in primary and secondary storage nodes according to this disclosure;

FIG. 4 is a diagram of an architecture of another data storage system according to this disclosure;

FIG. 5 is a diagram of an architecture of still another data storage system according to this disclosure; and

FIG. 6 is a schematic flowchart of a data storage method according to this disclosure.

### DETAILED DESCRIPTION OF ILLUSTRATIVE EMBODIMENTS

The following describes in detail embodiments of this disclosure with reference to the accompanying drawings.

For example, FIG. 1 is a diagram of an architecture of a system according to this disclosure. For example, the system includes a client, a container management cluster, a computing cluster, and a storage cluster.

The container management cluster may be for automatic deployment, capacity expansion, and operation and maintenance of a container cluster. For example, the container management cluster may include an application programming interface (API) server and a controller. The API server may serve as an external interface of the container management cluster. The client, computing cluster, and storage cluster all may access the container management cluster through the API server.

For example, the API server may be used by the client to deliver a container set creation request to the container management cluster. The controller may obtain the container set creation request from the API server, create a container set (pod) based on the container set creation request, and schedule the container set to a worker node for running. The container management cluster may be a Kubernetes cluster.

The computing cluster includes a plurality of worker nodes. The worker node may be a physical machine or a virtual machine (VM). The worker node may be deployed in different areas, or may use different operator networks. The worker node may run the container set in the worker node based on scheduling of the controller.

The storage cluster is configured to store data in the container management cluster, and the storage cluster may be an ETCD cluster.

Further, the storage cluster may include N storage nodes. The N storage nodes may further include a primary storage node (which may be referred to as a leader node) and a plurality of secondary storage nodes (which may be referred to as follower nodes). N nodes in the storage cluster may use a consensus algorithm Raft to perform leader election (or election) or data synchronization in a cluster.

In an election process, if a follower node in the storage cluster determines that a heartbeat from the leader node is not received in an election periodicity (election timeout), the follower node initiates an election procedure.

After switching the follower node to a candidate node, the follower node sends a request to another follower node in the storage cluster, to ask the another follower node whether to elect the follower node as the leader node. After receiving acceptance votes from (N/2+1) or more nodes in the storage cluster, the candidate node switches to the leader node, starts to receive and save data in the container management cluster, and synchronizes the data to the another follower node. The leader node depends on periodically sending the heartbeat to the follower node to maintain a status thereof.

In addition, if the another follower node does not receive the heart beat from the leader node during the election timeout, the another follower node also switches a status thereof to candidate and initiates election.

In a data synchronization process, after receiving the data from the container management cluster, the leader node in the storage cluster may first record the data, and then synchronize the data to the follower node through the heartbeat. The follower node records the data after receiving the data, and sends an acknowledgement (ACK) to the leader node. When the leader node receives ACKs sent from (N/2+1) or more follower nodes, the leader node sets the data to being submitted, and persistently stores the data in a local database. Then, the leader node notifies, in a next heartbeat, the follower node to store the data in a local database of the follower node.

Because the storage cluster uses the consensus algorithm Raft during the election or data synchronization, 2n+1 nodes need to be deployed in the storage cluster. Alternatively, it is understood that at least three nodes need to be deployed in the storage cluster. That is, N is an integer greater than or equal to three. However, in a scenario in which a quantity of nodes is limited, three or more nodes deployed in the storage cluster may not be ensured. Correspondingly, the storage cluster cannot run the consensus algorithm Raft to implement high availability of data storage.

Therefore, this disclosure provides a data storage system. The data storage system includes a storage cluster, and the storage cluster may be for storing data in a container management cluster. The storage cluster may be provided with two nodes, and the two nodes are respectively referred to as a primary storage node and a secondary storage node. The primary storage node and the secondary storage node may implement high availability of data storage in the container management cluster in a primary-and-secondary manner.

For ease of description, an example in which the container management cluster is a Kubernetes cluster is used for description below. Certainly, the container management cluster may alternatively be a cluster other than the Kubernetes cluster. This is not limited in this disclosure.

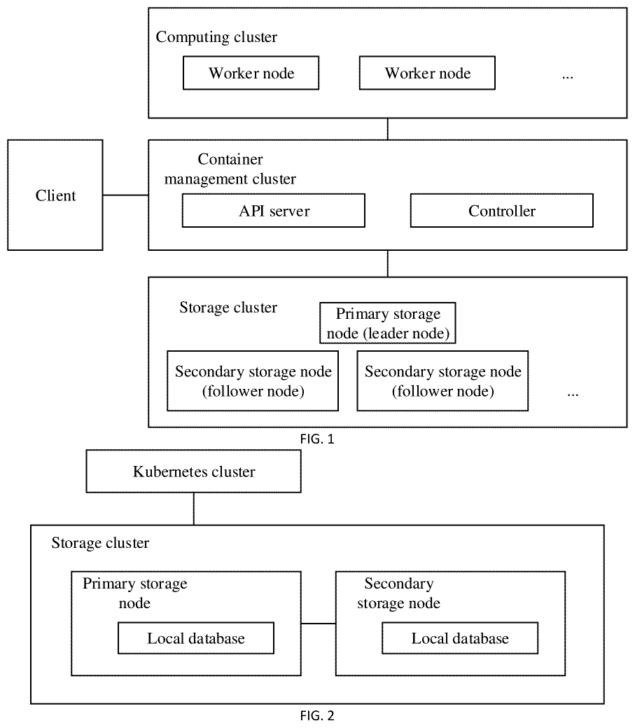

For example, FIG. 2 is a diagram of an architecture of the data storage system according to this disclosure. A storage cluster includes a primary storage node and a secondary storage node. The primary storage node is configured to obtain data (referred to as target data below) from a Kubernetes cluster corresponding to the storage cluster, and store the target data in a local database of the primary storage node. The primary storage node may further send the target data to the secondary storage node. Correspondingly, the secondary storage node receives the target data from the primary storage node, and synchronizes the target data to a local database of the secondary storage node.

In this way, the target data is stored in both the local database of the primary storage node and the local database of the secondary storage node. Further, the local database of the primary storage node may be understood as a primary database, and the local database of the secondary storage node may be understood as a secondary database. In this disclosure, high availability of data storage is ensured in a primary-and-secondary database manner. In addition, one storage cluster may include only two storage nodes, thereby reducing a quantity of storage nodes.

In a possible implementation, after obtaining the target data of the Kubernetes cluster, the primary storage node in the storage cluster may store the target data in the local database of the primary storage node in a key-value pair (K-V) manner.

Optionally, in the local database of the primary storage node, each key may further correspond to a plurality of versions. For example, if the primary storage node obtains (key1, value1) for the first time, and a version corresponding to (key1, value1) is rev1, the primary storage node may store rev1 and (key1, value1) in the local database of the primary storage node. Further, if the primary storage node obtains (key1, value1_new) for the second time, and a version corresponding to (key1, value1_new) is rev2, the primary storage node may store rev2 and (key1, value1_new) in the local database of the primary storage node again.

In this way, when querying the local database of the primary storage node for data, the Kubernetes cluster may enter a requested version and a key, to obtain a corresponding value through querying, thereby implementing multi-version concurrency control in the local database of the primary storage node.

Further, the local database of the secondary storage node may implement a storage mechanism similar to that of the local database of the primary storage node. When the primary storage node fails, a data storage and query service is provided.

Further, the primary storage node may further include a proxy interface, and the proxy interface communicates with an API server in the Kubernetes cluster. In addition, the secondary storage node may also include a proxy interface, for receiving a request from the API server when the secondary storage node switches to the primary storage node in the storage cluster. For details, refer to the following primary-and-secondary switch process.

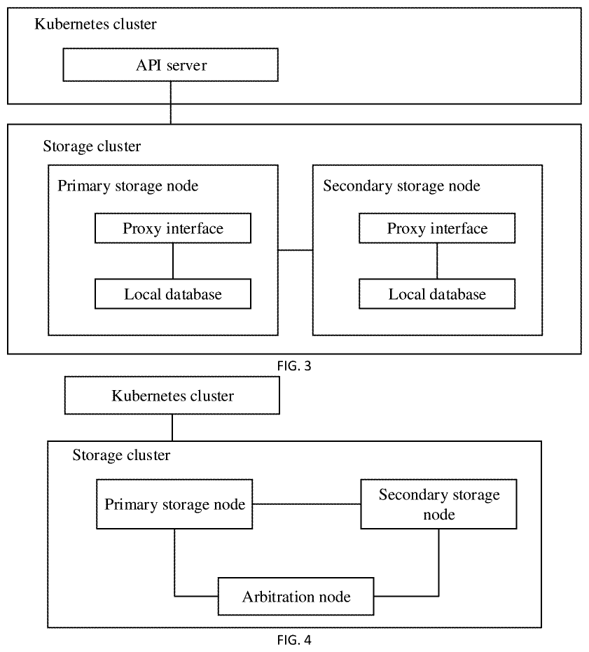

Refer to a diagram of proxy interfaces in the primary and secondary storage nodes shown in FIG. 3.

The proxy interface of the primary storage node may be for being compatible with an ETCD interface, and translating a request in the Kubernetes cluster into a request that can be parsed by the local database of the primary storage node. It is understood that, in this disclosure, because the storage cluster including the primary storage node and the secondary storage node replaces an ETCD cluster, and the request obtained by the primary storage node from the API server is still a request complying with the ETCD cluster interface, to store target data in the request in the local database, the primary storage node may convert, through the proxy interface, the request that is from the Kubernetes cluster and complies with the ETCD cluster interface into a request complying with the interface of the local database of the primary storage node in this disclosure.

For example, the local database of the primary storage node includes one or more of Oracle, MySQL, MongoDB, Redis, or the like. For example, when the local database of the primary storage node is MySQL, the proxy interface of the primary storage node converts the request that is from the Kubernetes cluster and complies with the ETCD cluster interface into a request complying with a MySQL interface.

In a specific implementation, the proxy interface in the primary storage node may receive a first request from the API server. The first request may be a write request, and the first request includes the target data to be written into the local database of the primary storage node. The proxy interface of the primary storage node performs protocol conversion on the first request, to obtain a second request supported by the local database of the primary storage node. It may be understood that, a difference between the second request and the first request lies in that protocol formats are different, but the second request and the first request include the same target data. Then, the proxy interface of the primary storage node may send the second request to the local database of the primary storage node. The local database of the primary storage node stores the target data in the second request.

For example, the target data included in the first request is a key-value and a version corresponding to a key. For example, the first request includes (key1, value1_new) and a version rev2, and the proxy interface of the primary storage node performs protocol conversion on the first request, to obtain the second request, where the second request still includes (key1, value1_new) and the version rev2. The proxy interface of the primary storage node sends the second request to the local database of the primary storage node, and the local database of the primary storage node stores rev2 and (key1, value1_new).

It should be noted that, the API server may randomly send the first request to the primary storage node or the secondary storage node. When the primary storage node receives the first request, the primary storage node determines that the primary storage node is a primary storage node in the current storage cluster, and then performs protocol conversion on the first request to obtain the second request.

When the secondary storage node receives the first request, the secondary storage node determines that the secondary storage node is not a primary storage node in the current storage cluster, and forwards the first request to the primary storage node. Correspondingly, the primary storage node receives the first request and determines that the primary storage node is a primary storage node in the current storage cluster, and performs protocol conversion on the first request to obtain the second request.

In addition, the proxy interface of the primary storage node may receive a third request from the API server. The third request may be a read request, and the third request includes index information of to-be-read data. The proxy interface of the primary storage node performs protocol conversion on the third request, to obtain a fourth request supported by the local database of the primary storage node. It may be understood that, a difference between the third request and the fourth request lies in that protocol formats are different, but the third request and the fourth request include the same index information of the to-be-read data. Then, the proxy interface of the primary storage node may send the fourth request to the local database of the primary storage node. The local database of the primary storage node returns corresponding data based on the index information in the fourth request.

For example, the index information of the to-be-read data included in the third request is a key and a version corresponding to the key. For example, the third request includes a key 1 and a version rev2, and the proxy interface of the primary storage node performs protocol conversion on the third request, to obtain the fourth request, where the fourth request still includes the key 1 and the version rev2. The proxy interface of the primary storage node sends the fourth request to the local database of the primary storage node, and the local database of the primary storage node queries for and returns a value1_new based on the key 1 and the version rev2.

It should be noted that, the API server may randomly send the third request to the primary storage node or the secondary storage node. When the primary storage node receives the third request, the primary storage node determines that the primary storage node is a primary storage node in the current storage cluster, and then performs protocol conversion on the third request to obtain the fourth request.

When the secondary storage node receives the third request, the secondary storage node determines that the secondary storage node is not a primary storage node in the current storage cluster, and forwards the third request to the primary storage node. Correspondingly, the primary storage node receives the third request and determines that the primary storage node is a primary storage node in the current storage cluster, and performs protocol conversion on the third request to obtain the fourth request.

In a possible implementation, data stored in the local database of the primary storage node may be specifically data of a container set of the Kubernetes cluster, for example, description information of the container set. The API server may further listen to a change of a key in the local database of the primary storage node through the proxy interface of the primary storage node, in other words, listen to a change of the description information of the container set. Correspondingly, when detecting, through listening, that the description information of the container set in the local database of the primary storage node changes, the API server manages, based on changed description information of the container set, the container set managed in the Kubernetes cluster, for example, deleting, starting, or scheduling the container set.

Optionally, the storage cluster may further include an arbitration node, and the arbitration node may be separately connected to the primary storage node and the secondary storage node. Refer to a diagram of an architecture of another data storage system according to this disclosure shown in FIG. 4.

The arbitration node is configured to monitor working statuses of the primary storage node and the secondary storage node, where a working status may be “normal” or “failed”. For example, the arbitration node may periodically monitor a heartbeat of the primary storage node, to determine whether the working status of the primary storage node is “normal”. Similarly, the arbitration node periodically monitors a heartbeat of the secondary storage node, to determine whether the working status of the secondary storage node is “normal”.

When determining that the working status of the primary storage node changes from “normal” to “failed” and the working status of the secondary storage node is “normal”, the arbitration node switches the secondary storage node to the primary storage node in the storage cluster. Correspondingly, when the Kubernetes cluster needs to store the target data in the storage cluster, the Kubernetes cluster may send the target data to the new primary storage node, and the new primary storage node may store the target data, to help ensure high availability of data in the entire storage system.

Optionally, the arbitration node may send a switch indication to the secondary storage node, where the switch indication indicates the secondary storage node to switch to the primary storage node in the storage cluster. Correspondingly, after receiving the switch indication, the secondary storage node switches, in response to the switch indication, the secondary storage node to the primary storage node in the storage cluster.

Further, only when determining that the working status of the primary storage node changes from “normal” to “failed” and the working status of the secondary storage node is “normal”, the arbitration node switches the secondary storage node to the primary storage node in the storage cluster. The arbitration node determines, based on the working statuses of the primary and secondary storage nodes, one of the two storage nodes as the primary storage node. This helps avoid a split-brain problem caused by mutual monitoring of the primary and secondary storage nodes. Explanations are as follows: In a process in which the primary and secondary storage nodes monitor each other, if a data link between the primary and secondary storage nodes is disconnected (where the primary storage node does not fail), the secondary storage node may mistakenly consider that the primary storage node fails and actively switch the secondary storage node to the primary storage node, causing a problem that two primary storage nodes exist (that is, the split-brain problem).

In this disclosure, the arbitration node may be alternatively deployed outside the storage cluster. It may alternatively be understood that, the storage system includes the storage cluster and the arbitration node. The arbitration node may be deployed together with an existing node. For example, the arbitration node is deployed together with the API server or a controller in the Kubernetes cluster. For another example, the arbitration node is deployed together with a worker node in a computing cluster. Alternatively, hardware such as a router in a cluster may be used as the arbitration node. In this way, the split-brain problem can be avoided without adding additional hardware.

To expand a scale of the data storage system, for example, FIG. 5 is a diagram of an architecture of still another data storage system. In the data storage system, M storage clusters (represented as a storage cluster 1 to a storage cluster M) are deployed, and each storage cluster includes a primary storage node and a secondary storage node. M is an integer greater than or equal to 2. Further, the data storage system may include an arbitration node. The arbitration node is separately connected to the primary storage node and the secondary storage node in each storage cluster, to monitor working statuses of the primary storage node and the secondary storage node in each storage cluster.

For example, a storage cluster K includes a primary storage node K and a secondary storage node K, where K is any integer from 1 to M. The arbitration node separately monitors working statuses of the primary storage node K and the secondary storage node K. In a monitoring periodicity, if determining that the working status of the primary storage node K changes from “normal” to “failed” and the working status of the secondary storage node Kis “normal”, the arbitration node indicates the secondary storage node K to switch to a primary storage node in the storage cluster K.

For an implementation in which the arbitration node indicates the secondary storage node K to switch to the primary storage node in the storage cluster K, refer to the foregoing implementation of a single storage cluster.

This helps avoid a split-brain problem in the storage cluster. In addition, the arbitration node monitors working statuses of the primary storage node and the secondary storage node in each of the M storage clusters. For example, when M=3, the entire storage system needs to include only one arbitration node and three pairs of primary and secondary nodes, that is, a total of seven nodes, to complete deployment of the storage system. This can further help reduce deployment costs in the storage system. In addition, when a quantity of storage clusters gradually increases, the deployment costs saved in the storage system are also larger.

Further, from the storage cluster 1 to the storage cluster M, local databases of the primary storage nodes in the storage clusters may form a primary database. From the storage cluster 1 to the storage cluster M, local databases of the secondary storage nodes in the storage clusters may form a secondary database. In this disclosure, the target data is stored in both the primary database and the secondary database, to ensure high availability of data storage in a primary-and-secondary database manner.

For ease of description, FIG. 4 and FIG. 5 merely show examples of the primary storage node and the secondary storage node included in the storage cluster. Further, each storage node also includes the local database and the proxy interface. In FIG. 2 to FIG. 5, the Kubernetes cluster also includes the API server, the controller, and the like.

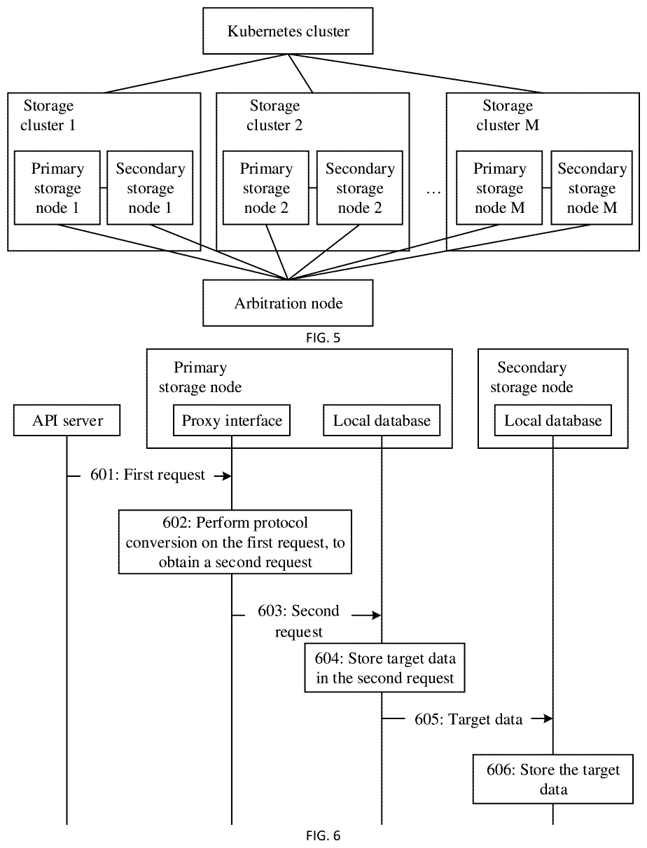

Based on the foregoing content and a same concept, FIG. 6 is a schematic flowchart of a data storage method according to this disclosure. The data storage method is applicable to the data storage systems shown in FIG. 2 to FIG. 5.

The data storage method includes the following steps.

Step 601: A proxy interface of a primary storage node receives a first request from an API server, where the first request includes target data to be written into a local database of the primary storage node.

Step 602: The proxy interface of the primary storage node performs protocol conversion on the first request, to obtain a second request supported by the local database of the primary storage node, where the second request includes the target data.

Step 603: The proxy interface of the primary storage node sends the second request to the local database of the primary storage node.

Step 604: The local database of the primary storage node stores the target data in the second request.

Step 605: The local database of the primary storage node sends the target data to a local database of a secondary storage node.

Step 606: The local database of the secondary storage node stores the target data.

For a step that is not described in detail in FIG. 6, refer to descriptions in the related embodiments in FIG. 2 to FIG. 5.

Based on the foregoing content and a same concept, this disclosure provides a data storage device, including a processor. The processor is connected to a memory, the memory is configured to store a computer program, and the processor is configured to execute the computer program stored in the memory, to enable the data storage device to perform the method in the related embodiment in FIG. 6.

Based on the foregoing content and a same concept, this disclosure provides a computer-readable storage medium. The computer-readable storage medium stores a computer program or instructions. When the computer program or the instructions are executed by a data storage device, the method in the related embodiment in FIG. 6 is implemented.

Based on the foregoing content and a same concept, this disclosure provides a computer program product. The computer program product includes a computer program or instructions. When the computer program or the instructions are executed by a data storage device, the data storage device implements the method in the related embodiment in FIG. 6.

It may be understood that, various numbers in embodiments of this disclosure are merely used for differentiation for ease of description, and are not used to limit the scope of embodiments of this disclosure. Sequence numbers of the foregoing processes do not mean execution sequences, and the execution sequences of the processes should be determined based on functions and internal logic of the processes.

It is clear that a person skilled in the art may make various modifications and variations to this disclosure without departing from the protection scope of this disclosure. This disclosure is intended to cover these modifications and variations of this disclosure provided that they fall within the scope of protection defined by the following claims and their equivalent technologies.

What is claimed is:

1. A storage cluster comprising:
a primary storage node is configured to: obtain data from a container management cluster, store the data in a local database of the primary storage node, and send the data to a secondary storage node; and
the secondary storage node is configured to: store the data in a local database of the secondary storage node.

2. The storage cluster according to claim 1, wherein a proxy interface of the primary storage node communicates with an application programming interface server API server in the container management cluster;
the proxy interface of the primary storage node is configured to perform protocol conversion on a first request from the API server, to obtain a second request supported by the local database of the primary storage node; and send the second request to the local database of the primary storage node; and
the local database of the primary storage node is configured to store the data comprised in the second request.

3. The storage cluster according to claim 1, wherein the storage cluster further comprises an arbitration node, and the arbitration node is separately connected to the primary storage node and the secondary storage node; and
the arbitration node is configured to:
monitor working statuses of the primary storage node and the secondary storage node; and
when determining that the working status of the primary storage node changes from normal to failed and the working status of the secondary storage node is normal, switch the secondary storage node to the primary storage node in the storage cluster.

4. The storage cluster according to claim 1, wherein there are a plurality of storage clusters, a arbitration node is separately connected to two storage nodes in each storage cluster; and
the arbitration node is configured to:
monitor working statuses of the two storage nodes in each storage cluster; and
when determining that a working status of a primary storage node changes from normal to failed and a working status of a secondary storage node is normal in any one of the plurality of storage clusters, switch the secondary storage node in the storage cluster to the primary storage node in the storage cluster.

5. The storage cluster according to claim 3, wherein when switching the secondary storage node to the primary storage node in the storage cluster, the arbitration node is specifically configured to send a switch indication to the secondary storage node, wherein the switch indication indicates the secondary storage node to switch to the primary storage node in the storage cluster; and
the secondary storage node is further configured to switch to the primary storage node in the storage cluster based on the switch indication.

6. The storage cluster according to claim 1, wherein the container management cluster is a Kubernetes cluster.

7. A data storage method, comprises:
obtaining, by a primary storage node of a storage cluster, data from a container management cluster, storing the data in a local database of the primary storage node, and sending the data to the secondary storage node; and
storing, by the secondary storage node of the storage cluster, the data in a local database of the secondary storage node.

8. The method according to claim 7, wherein a proxy interface of the primary storage node communicates with an interface server API server in the container management cluster; and
the obtaining, by the primary storage node, data from a container management cluster, storing the data in a local database of the primary storage node comprises:
receiving, by the proxy interface of the primary storage node, a first request from the API server; performing protocol conversion on the first request, to obtain a second request supported by the local database of the primary storage node; and sending the second request to the local database of the primary storage node; and
storing, by the local database of the primary storage node, the data comprised in the second request.

9. The method according to claim 7, wherein the storage cluster further comprises an arbitration node, and the arbitration node is separately connected to the primary storage node and the secondary storage node;
the arbitration node monitors working statuses of the primary storage node and the secondary storage node; and
when the working status of the primary storage node changes from normal to failed and the working status of the secondary storage node is normal, the arbitration node switches the secondary storage node to the primary storage node in the storage cluster.

10. The method according to claim 7, wherein there are a plurality of storage clusters, a arbitration node is separately connected to two storage nodes in each storage cluster;
the arbitration node monitors working statuses of the two storage nodes in each storage cluster; and
when a working status of a primary storage node changes from normal to failed and a working status of a secondary storage node is normal in any one of the plurality of storage clusters, the arbitration node switches the secondary storage node in the storage cluster to the primary storage node in the storage cluster.

11. The method according to claim 9, wherein that the arbitration node switches the secondary storage node to the primary storage node in the storage cluster comprises:
sending, by the arbitration node, a switch indication to the secondary storage node, wherein the switch indication indicates the secondary storage node to switch to the primary storage node in the storage cluster; and
switching, by the secondary storage node, to the primary storage node in the storage cluster based on the switch indication.

12. The method according to claim 7, wherein the container management cluster is a Kubernetes cluster.

13. A computer program product, when the computer program product is executed by a storage cluster, cause the storage cluster to perform steps of:
obtaining, by a primary storage node of a storage cluster, data from a container management cluster, storing the data in a local database of the primary storage node, and sending the data to the secondary storage node; and
storing, by the secondary storage node of the storage cluster, the data in a local database of the secondary storage node.

14. The method according to claim 13, wherein a proxy interface of the primary storage node communicates with an interface server API server in the container management cluster; and
the step of obtaining, by the primary storage node, data from a container management cluster, storing the data in a local database of the primary storage node comprises:
receiving, by the proxy interface of the primary storage node, a first request from the API server; performing protocol conversion on the first request, to obtain a second request supported by the local database of the primary storage node; and sending the second request to the local database of the primary storage node; and
storing, by the local database of the primary storage node, the data comprised in the second request.

15. The method according to claim 13, wherein the storage cluster further comprises an arbitration node, and the arbitration node is separately connected to the primary storage node and the secondary storage node, the steps of further comprises:
monitoring, by the arbitration node, working statuses of the primary storage node and the secondary storage node; and
switching, by the arbitration node, the secondary storage node to the primary storage node in the storage cluster when the working status of the primary storage node changes from normal to failed and the working status of the secondary storage node is normal.

16. The method according to claim 13, wherein there are a plurality of storage clusters, an arbitration node is separately connected to two storage nodes in each storage cluster;
the steps further comprises:
monitoring, by the arbitration node, working statuses of the two storage nodes in each storage cluster; and
switching, by the arbitration node, the secondary storage node in the storage cluster to the primary storage node in the storage cluster when a working status of a primary storage node changes from normal to failed and a working status of a secondary storage node is normal in any one of the plurality of storage clusters.

17. The method according to claim 15, wherein the switching step comprises:
sending, by the arbitration node, a switch indication to the secondary storage node, wherein the switch indication indicates the secondary storage node to switch to the primary storage node in the storage cluster; and
switching, by the secondary storage node, to the primary storage node in the storage cluster based on the switch indication.
